(19) United States
(12) Patent Application Publication
(10) Pub. No.: US 2007/0005309 A1
(43) Pub. Date: Jan. 4, 2007

(54) Three-dimensional finite element analysis of laser cavities

(76) Inventor: Konrad Altmann, Munchen (DE)

Correspondence Address: SMITH-HILL AND BEDELL, P.C., 16100 NW CORNELL ROAD, SUITE 220, BEAVERTON, OR, 97006, US

(21) Appl. No.: 11/174,149

(22) Filed: Jul. 1, 2005

(51) Int. Cl. G06F 17/10

(52) U.S. Cl. 703/2

(57) ABSTRACT

In a Finite Element Analysis (FEA) method to compute eigenmodes, time dependent dynamic mode structure, stability, beam quality, and laser power output of a laser cavity, the number of nodes of the discretization grid necessary to obtain sufficient accuracy is reduced by the use of a transformation of the differential equations describing the electromagnetic field. This removes the periodic fluctuations of the electromagnetic field from the mathematical expressions by the use of a product representation for the field variables with one term representing the periodic field oscillations, which have a scale length corresponding to the wave length, and another term representing the transformed field variables which are almost free of these small scale oscillations.

### FIELD OF INVENTION

The invention concerns the numerical computation of eigenmodes, beam quality, stability, and power output of laser cavities, as well as the time dependent simulation of the dynamic mode structure of laser cavities.

### DESCRIPTION OF RELATED ART

To compute the eigenmodes of a laser cavity basically two methods are available at the moment, the gaussian mode or ABCD matrix algorithm, and the beam propagation method (BPM).

The gaussian mode algorithm is a very fast method to compute eigenmodes and also power output of a laser cavity. The problem with this algorithm is that it only can be used if the laser beam is propagating through spherical (or more precisely, parabolic) dielectric interfaces, gaussian ducts, i.e. sections of the propagation path with parabolic distributions of refractive index and gain, or if the beam is reflected on spherical mirrors. In real situations, the gaussian mode algorithm can be successfully applied, if the distributions of refractive index and gain in a laser crystal can be approximated by parabolic fits.

For situations where the gaussian mode algorithm is not sufficient a physical optics beam propagation method is currently being used. The method is based on a round-trip integral operator, and goes back to the early work of Fox and Li /1/. The principle of this method is to propagate a wave front numerically for instance by the use of a Fast Fourier Transform (FFT) method in small steps back and forth between the end mirrors of a cavity. The initial field distribution can more or less be chosen arbitrary. The iteratively recirculated field distribution converges to the lowest order mode or to a combination of higher order transversal modes, dependent on diffraction losses of the latter ones. To some extent, this procedure mimics the real physical process in a cavity. However, there are several problems. Convergence cannot be generally predicted. Even if the procedure converges to the lowest-order mode, usually an admixture of higher order modes remains, making it difficult to isolate the exact shape of the lowest-order mode.

To extract particular eigenmodes it has been proposed to sample the fluctuating distributions of the optical field, generated after each round-trip, at a certain reference plane for instance at one of the end mirrors. The sampled distributions can be analyzed by the use of a field correlation function in combination with FFT methods as proposed by Feit and Fleck /2/, or alternatively by the use of the Prony method as shown by Siegman and Miller /3/. Since both methods use field patterns, being generated in a first step, and compute eigenvalues in a second and eigenmodes in a third step, they depend on the accuracy of these primarily generated patterns. Practical experience with BPM shows that fluctuations due to limited computational accuracy can affect the appearance of these patterns considerably, and therefore the numerical results obtained for the eigenmodes usually are not very exact.

Another problem with BPM is the fact that this method only considers one propagating wave front at a particular time, and not simultaneously the optical field distribution in the whole cavity, as it is necessary to analyze time dependent effects.

### STATEMENT OF THE INVENTION

In view of the above-mentioned problems in the present invention a new method is being disclosed to numerically analyze and simulate the behavior of a laser cavity i.e. to compute eigenmodes, time dependent dynamic mode structure, stability, beam quality, and laser power output. The new method uses a Finite Element Analysis (FEA) procedure to solve the differential equations describing the electromagnetic field in the cavity. The latter can be expressed in form of the scalar wave equation, the Helmholtz equation, or the Maxwell equations. Concerning the application a FEA approach to solve the electromagnetic differential equations of a laser cavity the most serious problem consists in the fact that the solutions for the field are showing periodic small scale spatial oscillations in propagation direction having a scale length corresponding to the wave length of the electromagnetic field. To realize sufficient accuracy the discretization grid used with the FEA must be fine enough to take into account these oscillations. Assuming for instance that 20 nodal points a necessary to digitally dissolve the shape of the field along one antinode of oscillation, in case of a 10 mm long cavity and a wave length of 0.001 mm a number of 200.000 nodes is necessary in direction of the axis of the cavity (z-axis). Combining the z-axis discretization with 100 nodes in both transverse directions one obtains the huge number of 2*10⁹ nodes. This constitutes a numerical task which only can be handled on large mainframe computers, and affords considerably long computational times.

With the new method being disclosed this problem is solved in a surprisingly efficient way by the use of a transformation of the electromagnetic differential equations which removes the periodic fluctuations of the electromagnetic field from the mathematical expressions. For this purpose a product representation is used for the field variables with one term representing the periodic oscillations of the field and a second term representing the transformed field variables which are almost free of these small scale oscillations. For instance in case of the scalar wave equation or the Helmholtz equation the phasor amplitude \tilde{E}(x,y,z) of the electromagnetic field can be factorized as follows
\tilde{E}(x,y,z)=exp [−i(k_{f}−ε)z]ũ(x,y,z).
Here k_{f} is the propagation constant of the free wave. The quantity ε takes into account that a guided wave generally has a propagation constant, which is smaller than the propagation constant k_{f} of the free wave, as well known from texts on wave guide or laser theory /4/. As shown in the attached publications (Applied Optics, Vol. 43, 1892-1901 (2004) and Proc. of SPIE Vol. 5333-16, 18-29 (2004)) the transformed field variable ũ(x,y,z) overall can be expected to be free of the above-mentioned small scale spatial oscillations. The transformed differential equations are shown in the attached publications, and therefore, are not repeated here.

Since the FEA approach is solving the differential equations directly instead of using a round-trip integral operator, the eigenmodes can be computed directly which makes it possible to realize much higher accuracy as with the use of BPM. Examples are presented in the attached papers.

Different from the BPM method which only considers one propagating wave front, the FEA approach simultaneously involves the whole volume of the cavity. It is proposed to use this feature to simulate the time dependent dynamic mode structure of a laser by the use of a coupled set of partial differential equations representing a combination of the differential equations for the electromagnetic field and the laser rate equations describing the time dependent population inversion in the cavity. In this way the following FEA model has been derived

$$μɛ \frac{{\partial }^{2} {u}_{l}}{\partial {t}^{2}} + 2 jμɛω \frac{\partial {u}_{l}}{\partial t} = Δ {u}_{l} - 2 {jk}_{f} \frac{\partial {u}_{l}}{\partial z} - {k}_{s} ( 2 {k}_{f} - {k}_{s} ) {u}_{l}$$

$$μɛ \frac{{\partial }^{2} {u}_{r}}{\partial {t}^{2}} + 2 jμɛω \frac{\partial {u}_{r}}{\partial t} = Δ {u}_{r} + 2 {jk}_{f} \frac{\partial {u}_{r}}{\partial z} - {k}_{s} ( 2 {k}_{f} - {k}_{s} ) {u}_{r}$$

$$\frac{\partial N}{\partial t} = - γ N σ \frac{ɛ}{2 ℏω} ( {\vert {u}_{r} \vert}^{2} + {\vert {u}_{l} \vert}^{2} ) - \frac{N + {N}_{tot} ( γ - 1 )}{{τ}_{f}} + {R}_{p} ( {N}_{tot} - N )$$

The model is stable with respect to the coordinates of position, and by the use of a stable finite element discretization with respect to the time it is possible to simulate the time dependent behavior of a laser or longer period of time. In the above equations N is the population inversion density, Nₜₒₜ is the doping density, Rₚ the pump rate, σ the cross-section of stimulated emission, k_{f(s)} are propagation constants.

In case of semiconductor lasers it is proposed to add the differential equations for the carrier density to the above set of coupled partial differential equations.

To solve the eigenvalue problem it is proposed to use a shift-and-invert method, and to solve the equations in the invert part using a preconditioned generalized minimal residual algorithm (GMRES) /5/. Additionally it is proposed to use a Jacobi-Davidson algorithm to compute the eigen modes.

In case of a standing wave resonator it is proposed that the electromagnetic wave traveling back and forth between the end mirrors is represented by a superposition of two waves traveling in opposite directions by the use of a two-wave Ansatz, and to couple the two waves by the use of appropriate coupling conditions.

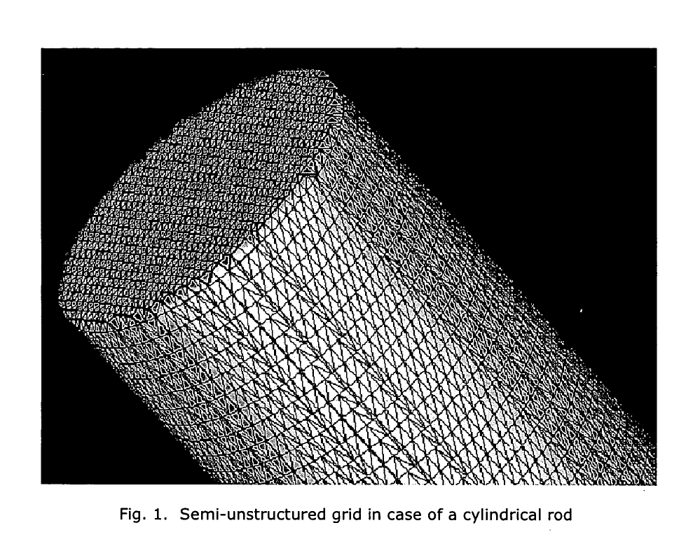

Further it is proposed to use a semi-unstructured mesh for the spatial discretization /6,7/ in a way that the mesh being regular inside coherent 3D computational domains is slightly deformed in the neighborhood of boundaries or optical elements to obtain appropriate adjustment as shown in FIG. 1.

Further it is proposed to use the concept of expression templates with the numerical solution algorithm.

Since thermal problems considerably affect the behavior of solid-state lasers, it is proposed to combine the electromagnetic FEA with a FEA computing temperature distribution and structural of deformation of the laser crystal. To take into account the feedback of power output coupling on the thermal effects it is proposed to carry through thermal-structural and electromagnetic FEA iteratively.

To enable easy modification of input parameters and control of the FEA codes the use of a Graphical User Interface is proposed which can be used to start the FEA codes, to define the input parameters, and to visualize the results.

In the attached publications Appendix A (K. Altmann. Ch. Pflaum, D. Seider, “Three-dimensional finite element computation of laser cavity eigenmodes”, Applied Optics, 43, 1892-1901 (2004)) and Appendix B (K. Altmann. Ch. Pflaum, D. Seider, “Three-dimensional computation of laser cavity eigenmodes by the use of finite element analysis (FEA)” Proc. of SPIE, Vol. 5333, Paper 5333-16, 18-29 (2004)) mathematical details and computational results of preferred embodiments of the invention are described. The publications have to be considered as part of the patent application.

### REFERENCES

/1/ A. G. Fox and T. Li, “Resonant modes in a maser interferometer”, Bell Syst. Tech. J. 40, 453-458 (1961)
/2/ M. D. Feit and J. A. Fleck, “Spectral approach to optical resonator theory”, Appl. Opt. 20(16), 2843-2851 (1981)
/3/ A. E. Siegman and H. Y. Miller, “Unstable optical resonator loss calculation using the Prony method”, Appl. Opt. 9(10), 2729-2736 (1970)
/4/ A. E. Siegman, Lasers (University Science Books, Mill Valley, 1986)
/5/ Y. Saad and M. H. Schultz, “GMRES: A generalized minimal residual algorithm for solving nonsymmetric linear systems”, SIAM 3. Sci. Stat. Comput. 7, 865-881 (1986).
/6/ Ch. Pflaum, “Semi-unstructured grids”, Computing, 67(2), 141-166 (2001)
/7/ K. Altmann, Ch. Pflaum, and D. Seider, “Semi-unstructured grids in the laser simulation program LASCAD”, Proceedings of GAMM 2002 (2002)
/8/ C. Pflaum, Expression Templates for Partial Differential Equations. Comput. Visual Sci., Volume 4, Issue 1, pp. 1-8, 2001.

1-12. (canceled)

13. Finite Element Analysis (FEA) method to compute eigenmodes, stability, beam quality, laser power output, and time dependent dynamic mode structure of a laser cavity, wherein the number of nodes of the discretization grid necessary to obtain sufficient accuracy is reduced by the use of a transformation of the differential equations describing the electromagnetic field, which removes the periodic fluctuations of the electromagnetic field from the mathematical expressions by the use of a product representation for the field variables with one term representing the periodic field oscillations, which have a scale length corresponding to the wave length, and an other term representing the transformed field variables which are almost free of these small scale oscillations.

14. FEA method as set forth in claim 13, wherein the differential equations describing the electromagnetic field have the form of the scalar wave equation, the Helmholtz equation, or the Maxwell equations.

15. FEA method as set forth in claim 13, wherein the method proposed in claim 13 is applied to a coupled set of partial differential equations representing a combination of the differential equations for the electromagnetic field and the laser rate equations describing the time and position dependent population inversion in the cavity.

16. FEA method as set forth in claim 15, wherein the coupled set of partial differential equations also contains a differential equation for the carrier density in case semiconductor lasers.

17. FEA method as set forth in claim 13, wherein in case of a standing wave resonator the electromagnetic wave traveling back and forth between the end mirrors is represented by a superposition of two waves traveling in opposite directions by the use of a two-wave Ansatz, and that the two waves are coupled by the use of appropriate coupling conditions.

18. FEA method as set forth in claim 13, wherein a semi-unstructured mesh is used with the FEA in a way that the mesh being regular inside coherent 3D computational domains is slightly deformed in the neighborhood of boundaries or optical elements to obtain appropriate adjustment.

19. FEA method as set forth in claim 13, wherein the concept of expression templates is used with the numerical solution algorithm.

20. FEA method as set forth in claim 13, wherein the eigenvalue problem is solved by the use of a shift-and-invert method, and that for the solutions of the equations in the invert part a preconditioned generalized minimal residual algorithm is used (GMRES).

21. FEA method as set forth in claim 13, wherein a Jacobi-Davidson Algorithm is used to compute the eigenmodes.

22. FEA method as set forth in claim 13, wherein a streamline diffusion-method is used to stabilize the numerical procedure being used to solve the differential equations.

23. FEA method as set forth in claim 13, wherein thermal effects in the laser cavity also are being analyzed by the use of an FEA method, in that the electromagnetic FEA is carried through after a thermal FEA, which computes the temperature distribution and the structural of deformation of the laser crystal, or in that both FEA codes are carried through alternating in an iterative way.

24. FEA method as set forth in claim 13, wherein thermal and/or electromagnetic FEA code can be controlled and started from a Graphical User Interface with means to define the input parameters, and to visualize the results.
